(19) United States
(12) Patent Application Publication
(10) Pub. No.: US 2011/0133468 A1
(43) Pub. Date: Jun. 9, 2011

(54) WIND POWERED GENERATING SYSTEM

(76) Inventor: JOHN LEITH, CHUBBUCK, ID (US)

(21) Appl. No.: 12/631,510

(22) Filed: Dec. 4, 2009

(51) Int. Cl. F03D 9/00

(52) U.S. Cl. 290/55

(57) ABSTRACT

A wind driven electrical generator, with a number of blades on a rotating blade disk, built into a structure such as a house, a shed, or a barn. A portion of the structure can serve to funnel or direct wind into the blades, to increase the electricity generated.

### FIELD OF THE INVENTION

The invention generally relates to an apparatus for generating electricity from wind, and more particularly to generators built into structures in homes and buildings.

### BACKGROUND OF THE INVENTION

There have been a number of devices which have been built to capture the energy of wind. One of the earliest ones that was patented in the United States was the patent to Halliday, U.S. Pat. No. 11,629 which is for a windmill with a tail, in which the tail always keep the blades of the windmill facing into the wind. This device was typically connected to a pump for pumping subsurface water into stock tanks on the western prairie of the United States.

Other devices have been utilized to use wind energy to produce electricity, including the current generation of windmills which can be mounted to boats or structures in which the propeller blades are like the propellers of an airplane, or may be propeller like with a band joining the tips of the blades for stability at high speeds.

With the costs of power generation certain to continue to increase as fossil fuels become scarce, there is still a need for production of electricity from windy areas of the United States in order for the country and individual consumers to be more self-sufficient as far as their energy needs.

An ideal wind generation structure for people who live in an area windy enough to justify it would be wind generation structures which are built into existing structures, such as: built into the structure of a house, a barn, or a garage; built into a sidewall of any of these structures; or into the roof of these structures. What is needed is electrical generation systems which can easily be adapted for use in existing structures, such as the walls and roofs of buildings.

### SUMMARY OF THE INVENTION

The invention is a wind powered electrical generating system which is incorporated into the structure of a building. The generating system of the invention includes one or more rotary impeller fan units, with one version having a horizontally oriented axle and another having a vertical axle. The fan unit includes a generally vertically oriented planar blade disk which is mounted for rotation on the axle. The blade disk can be on one side only of the fan blades, or it can be on both sides of the blades. Alternatively, the blade disk may be mounted fixedly to the axle, with the axle being configured to rotate and to be supported by one or more bearings at either one or both of its ends. The blade disk is a round and flat disk to which are attached a number of flat blades mounted along the periphery of the disk. The blades are mounted with a radial orientation to the axle. The blades can be flat and planar or they can be flat and have a curved shape. The blade disk is oriented to be exposed to a prevailing wind in the location in which it is established, and to rotate in the wind for the purpose of generating electricity.

The fan unit includes a fan surrounding structure which partially encloses the blade disk and its attached blades. The fan surrounding structure blocks the wind from impacting half, or at least some, of the blades and directs air into the unobstructed portion of the blade disk. The unobstructed portion of the blade disk forms an air intake region which may be on the top portion or the bottom portion of the blade disk, and which faces into the wind.

The blade disk includes a generator contact strip which is attached to the periphery of the blade disk. The generator contact strip provides a surface for contact with a generator, so that rotation of the blade disk can be converted into a rotation of the generator, for the purpose of generating electricity. The system thus, also includes a generator which is in functional engagement with the generator contact strip and is configured to turn to convert movement of the blade disk into electricity. The generator can be in contact with the blade disk through a wheel on the generator which is in frictional contact with the generator contact strip. The generator can also be in functional engagement with the generator contact strip by the use of gear teeth in either or both of the generator and the generator contact strip. Other connection strategies can be utilized, such as having the axle have gears, or running a belt or chain off the axle to turn the generator.

The axle of the rotary impeller fan can be supported on one side or both sides of the axle, with the fan surrounding structure providing support for the outboard side of the axle. The inboard side of the axle is adjacent to the building wall and may be supported by being attached to the building wall or to some other supporting structure.

The wind powered electrical generating system of the invention can be placed against a building wall so that the building wall itself serves as a channel for deflecting the prevailing wind and directing it into the air intake region of the fan unit. This can be accomplished by selecting a wall of an existing building which presents the best angle to the prevailing wind, and building the wind powered generating system against that wall so that the maximum volume of wind will be deflected and directed into the air intake region of the fan. The fan can also utilize the prevailing wind by being incorporated into a purpose build building, with a long wall of the building directed at an angle to the prevailing wind so that the maximum amount of wind is directed along the wall and into the air intake channel. In either the retrofit, or the purpose build configuration, auxiliary structures can be built to further direct and channel the wind into the air intake region. This can take the form of ramps built into the wall of the building, or adjacent buildings positioned to contribute to a funneling effect of wind passing between the two buildings.

One configuration of the wind powered electrical generating system of the invention is one in which the fan unit is built into a building so that a portion of the blade disk is exposed through the roof of the building. This can be accomplished by incorporating the air intake region into a portion of the roof, with the portion of the roof below the air intake region serving as a ramp to channel air into the air intake region. A structure below the roof can further serve as part of the air ramp, and deflect wind onto the roof of the house and into the air intake region in the roof. In this type of configuration, the air intake region of the fan can also be covered by an overhanging roof portion which serves to keep rain out of contact with the blade disk, and also serves as an air entrapment funnel to direct more air into the air intake region of the device.

A fan of the invention can take the form of a fan with a vertical axis, with the blade disk positioned horizontal to the ground. The blade disk may be a solid piece or may be a ring like structure. In this embodiment of the device, the blades of the fan can be more or less shaped like the profile of a conifer tree, with the blades and the blade disk being configured to turn in the wind and to power a generator by contact with the blade disk. An auxiliary structure can be present in this device which attaches to the top of the axle and stabilizes the spinning of the tree like fan blades at high speeds.

### BRIEF DESCRIPTION OF THE DRAWINGS

FIG. 1 is a perspective view showing two versions of the wind powered generators of the invention.

FIG. 2 is a perspective cut away view of a house showing the connection of a generator to the fan blades of a wind generator.

FIG. 3 is a perspective view of a tree shaped wind generator of the invention.

FIG. 4 is a perspective view of an alternative version of the tree shaped wind generator of the invention.

FIG. 5 is a perspective view of a wind generation system of the invention built into a shed.

### DESCRIPTION OF THE PREFERRED EMBODIMENTS

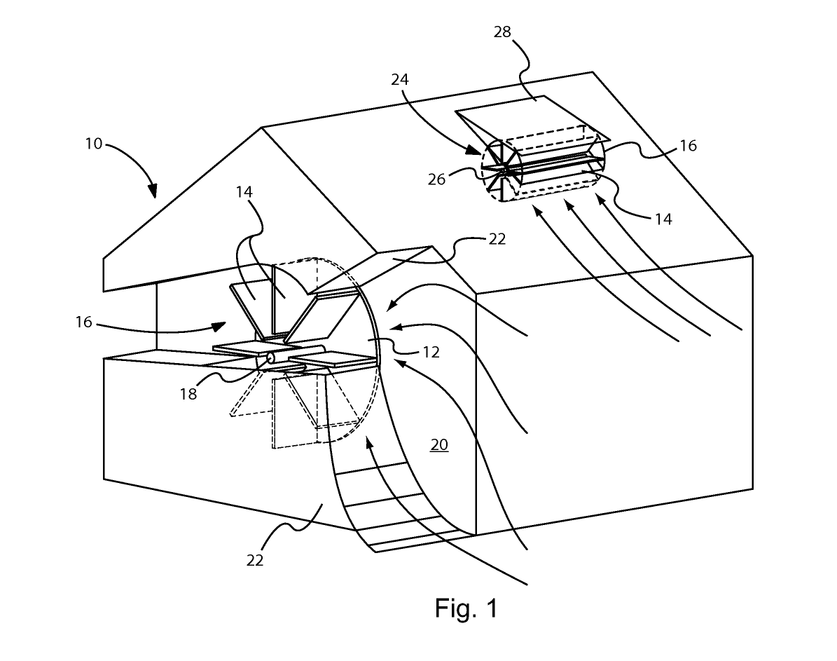

The wind generation system of the invention is shown to advantage in FIGS. 1-5. FIG. 1 shows the wind powered electrical generating system of the invention, designated as 10, built into a sidewall 20 and roof 46 of a building which could be a house, a barn, a garage, a shed, or other building. The system shown in FIG. 1 includes a rotary impeller fan unit 16, a horizontally oriented axis 18, a blade disk 12, a number of radially mounted flat blades 14, with the fan unit 16 mounted on a building sidewall 20.

Also show in FIG. 1 is a fan surrounding structure 22 which directs air into the fan blades 14, as well as shields the lower half of the blades from contact with the wind, in order to increase the rotation of the fan blades 14 and blade disk 12. The structure shown in FIG. 1 has a fan surrounding structure 22 below the fan blades, as well as above the fan blades, which creates a funnel effect and causes more wind to be directed into the fan blades 14.

Not shown in FIG. 1 is the connection of the blade disk 12 and the generator for generating electricity which is shown in other figures.

Also shown in FIG. 1 is another type of rotary impeller fan unit 16, with this unit being a roof mounted fan unit 24, with a horizontal axis 26, and fan blades 14. In the case of the roof mounted fan unit 24, the fan unit may be housed in an overhanging roof portion 28, which protects the unit from rain, and also serves to channel air into the fan blades 14.

In the rotary impeller fan unit 16, shown mounted to a building sidewall 20, the size of the unit can vary according to the particular installation and for the type of winds present in the prevailing wind patterns of the area. An example of a system could include a blade disk 12, which is approximately 60 inches in diameter, with fan blades 14, which are approximately 48 inches by 24 inches. As shown in FIG. 1, the axle 18 may be supported on one side, or it may be supported on two sides, with support being provided in the fan surrounding structure 22 or other structure. In the example of FIG. 1, the fan blades 14 are flat and rectangular, but curving or cupped blades are also possibilities.

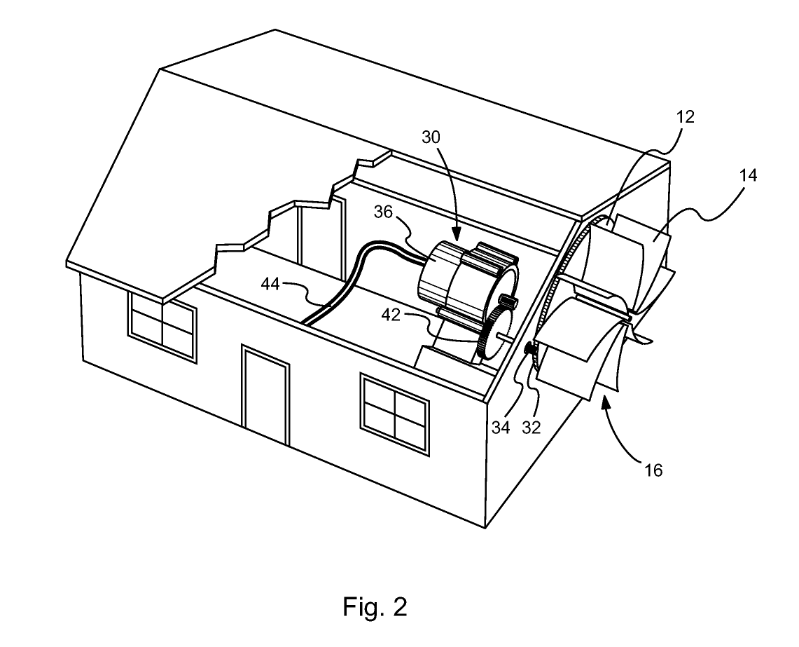

FIG. 2 shows a detail of a rotary impeller fan unit 16 which shows details of the connection to a generating system 30. The example shown in FIG. 2 includes a blade disk 12 with attached fan blades 14. In this case, the fan blades 14 are curved, although they remain flat structures. The blade disk 12 includes a generator contact strip 32 which is on the periphery of the blade disk. Although shown in FIG. 2 to be a connection using gear teeth, the generator contact strip 32 can also be a friction connection with the generator. The generating system 30 includes a contact wheel 34 which is powered by the generator contact strip on the periphery of the blade disk 12. As noted, the contact wheel can be a geared or a friction contact. Power is transmitted from the contact wheel 34 by gearing 42 to the generator 36. Power from the generator 36 is delivered to the household or optionally to the electrical grid of the region by power lines 44, which would include standard electrical equipment to provide power to the house or to the local distribution grid.

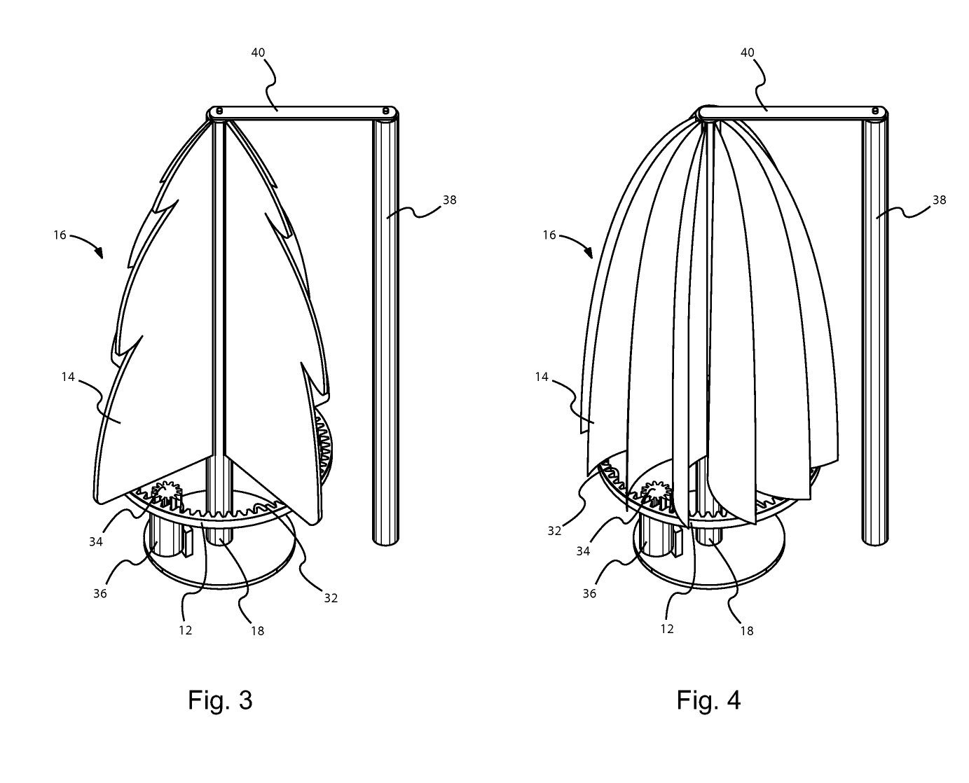

FIG. 3 shows a rotary impeller fan unit 16 configured to resemble a tree. In this way, the fan unit can be fairly inconspicuous on a residential yard, or in a park, or in a field, and can be placed to capture wind energy. The device includes fan blades 14, as in the other embodiments, and a blade disk 12. In this case, the blade disk 12 is a gear ring and has the generator contact strip 32 on the inside surface and contacts a contact wheel 34 in the form of a geared wheel. The generator 36 is shown directly connected to the contact wheel, but geared connections are also possible. In this case, the axle 18 is vertical. A stabilizing post 38 can be placed next to the tree shaped rotary impeller fan unit 16, with a connecting bar 40 attached to the upper end of the axle 18. This would serve to give more stability to the spinning fan blades and blade disk 12 in the case of high winds. Also included with the tree shaped fan unit of FIG. 3 can be a structure which shields half of the fan blades from oncoming wind. Also, environmental structures can be built to complement the tree shaped fan unit, and to funnel and direct air into the fan blades 14. This can be something as simple as a wall or a pair of walls which form the funnel, or the tree shaped fan unit can be placed at the end of a building wall where the prevailing wind is likely to strike the wall and be directed into the fan blades of the tree shaped fan unit.

While there is shown and described the present preferred embodiment of the invention, it is to be distinctly understood that this invention is not limited thereto but may be variously embodied to practice within the scope of the following claims. From the foregoing description, it will be apparent that various changes may be made without departing from the spirit and scope of the invention as defined by the following claims.

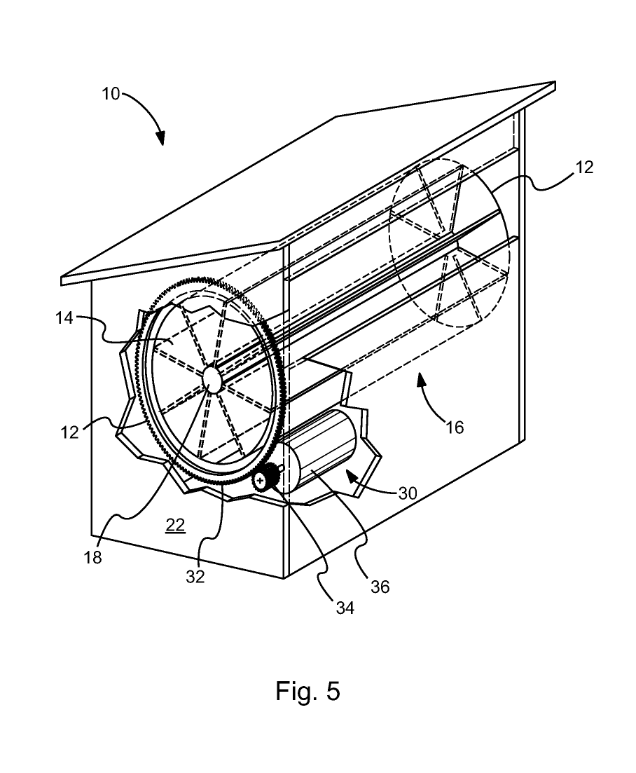

FIG. 4 is a variation of the tree fan of FIG. 3, and shows a fan configuration in which the fan blades 14 are curved, and there are more of them. Otherwise this tree fan is the same as that shown in FIG. 4 of the invention. The curved blades render a unit with a uni-directional character; in other words, whichever direction the wind is coming from, the unit will turn in the same direction.

FIG. 5 shows a version of the wind generating system 10 of the invention in which the rotary impeller fan unit 16 is built into a shed. A structure such as this could also extend from the top of another building such as a house or a barn, or could be part of a larger building which included room for other purposes such as storage of equipment. The rotary impeller fan unit 16 of FIG. 5 includes a blade disk 12, fan blades 14, a horizontal axle 18, a fan surrounding structure 22, a generating system 30, which includes a generator 36, a contact wheel 34, and a generator contact strip 32. This version of the device would function in a similar manner as the other versions with the blade disk 12 and fan blades 14 being turned by the wind

What is claimed is:

1. A wind powered electrical generating system comprised of one or more rotating fans configured for wind propulsion, with said fans incorporated into an existing building.

2. A wind powered electrical generating system for incorporating into a building, comprising:
a rotary impeller fan unit with a horizontal oriented axle, said fan comprising a planar blade disk rotatably mounted on said axle with a plurality of flat blades mounted thereon, with said blades mounted radial to said axle and at a periphery of said blade disk, with said fan unit permanently mounted on a building sidewall, with said blade disk configured to rotate in the wind;
a fan surrounding structure which blocks wind from impacting a lower half of said blade disk, with said fan surrounding structure further shaped to direct wind into an air intake region and into said fan blades;
a generator contact strip attached to a periphery of said blade disk, to provide a surface for a generator to contact said blade disk for turning said generator for producing electricity; and
a generator in functional engagement with said generator contact strip and configured to turn movement of said blade disk into electricity.

3. The wind powered electrical generating system of claim 2 in which said fan surrounding structure provides an outboard support for said axle, with said inboard axle support being adjacent to said building wall.

4. The wind powered electrical generating system of claim 2 in which said fan blades are generally planar in configuration.

5. The wind powered electrical generating system of claim 2 in which said fan blades are generally flat and curved in shape.

6. The wind powered electrical generating system of claim 2 in which said fan unit is placed against a building wall with said building wall oriented to be impacted by wind from a prevailing wind direction, and to deflect and channel wind into said air intake region.

7. The wind powered electrical generating system of claim 2 in which said fan unit is built into a building with said air intake region built into a roof of the building.

8. The wind powered electrical generating system of claim 7 in which a portion of the roof of the building forms a ramp for channeling wind into said air intake region, with said roof including an overhanging portion which overhangs said blade disk and helps to channel wind into said air intake region.

9. The wind powered electrical generating system of claim 2 in which said blade disk is mounted horizontally, with said blade shaped to resemble conifer trees, and to thus form unobtrusive windmills in an open area.
